(19) United States
(12) Patent Application Publication
(10) Pub. No.: US 2024/0365403 A1
(43) Pub. Date: Oct. 31, 2024

(54) GATEWAY APPARATUS, NETWORK SERVICE APPARATUS, COMMUNICATION APPARATUS AND METHODS

(71) Applicant: BLECON LTD, Impington, Cambridge Cambridgeshire (GB)

(72) Inventor: Simon Andrew Ford, Impington, Cambridge Cambridgeshire (GB)

(21) Appl. No.: 18/692,131

(22) PCT Filed: Oct. 17, 2022
(86) PCT No.: PCT/GB2022/052641

§ 371 Date: Mar. 14, 2024

(30) Foreign Application Priority Data
Oct. 19, 2021 (GB) 2114946.3

(51) Int. Cl. H04W 76/10; H04W 4/80; H04W 12/06

(52) U.S. Cl. CPC H04W 76/10; H04W 12/06; H04W 4/80

(57) ABSTRACT

A gateway apparatus comprising circuitry configured to wirelessly receive, in a Bluetooth Low Energy advertising packet, an identifier of a communication apparatus and an indicator of whether the communication apparatus is requesting a wireless connection with a gateway apparatus; establish, in response to the Bluetooth Low Energy advertising packet indicating the communication apparatus is requesting a wireless connection with a gateway apparatus, a wireless connection with the communication apparatus; receive, via the established wireless connection, information from the communication apparatus associated with the identifier of the communication apparatus; and transmit the received information to a web service.

### BACKGROUND

### Field of the Disclosure

The present disclosure relates to a gateway apparatus, network service apparatus, communication apparatus and methods.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

It is often desirable for communication devices such as sensors to be able to wirelessly communicate with a web service. Existing wireless technologies can achieve this, each with different trade-offs. Considerations may include modem cost, bandwidth, power consumption and regional radio requirements, plus the cost of supporting equipment, infrastructure and installation.

The low cost, low power consumption and high bandwidth of Bluetooth® based devices would often be a preferable solution if they could meet the application needs whilst being practical to deploy. However, limitations of the current known techniques mean it is often not suitable.

Some relevant use cases are known to be supported for Bluetooth based devices.

One is communication devices that are paired with a smartphone, providing flexible and secure two-way communication between the device and app on a phone. No specific additional hardware or infrastructure is required. However, the device needs to be paired or associated with the specific smartphone to provide full functionality, making setup for interaction with a potentially large number of communication devices (e.g. sensors) impractical.

Another is marketing beacon devices or tracker devices that can advertise their presence to other devices (such as smartphones) nearby without prior pairing or association, including detection when a smartphone is in a sleeping state. Whilst excellent for simple applications requiring detecting the presence of many different devices with no pre-association, functionality is limited.

Another is communication devices that can communicate with dedicated always-on network infrastructure using protocols that support paired or unpaired two-way communication. Whilst the protocols used work well, they do not easily translate to e.g. smartphone implementations where functionality should persist even when a smartphone is in a sleeping state. As such, solutions are limited to those where dedicated network infrastructure is deployed.

There is therefore a desire to overcome these shortcomings.

### SUMMARY

The present disclosure is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 describes an example gateway apparatus, network service apparatus and communication apparatus;

FIG. 2 describes an example network (system);

FIG. 3 describes example Bluetooth Low Energy advertising packets;

FIG. 4 describes an example information flow;

FIG. 5 describes an example configuration screen;

FIG. 6 describes an example gateway apparatus method;

FIG. 7 describes an example network service apparatus method; and

FIG. 8 describes an example communication apparatus method.

Like reference numerals designate identical or corresponding parts throughout the drawings.

### DETAILED DESCRIPTION OF THE EMBODIMENTS

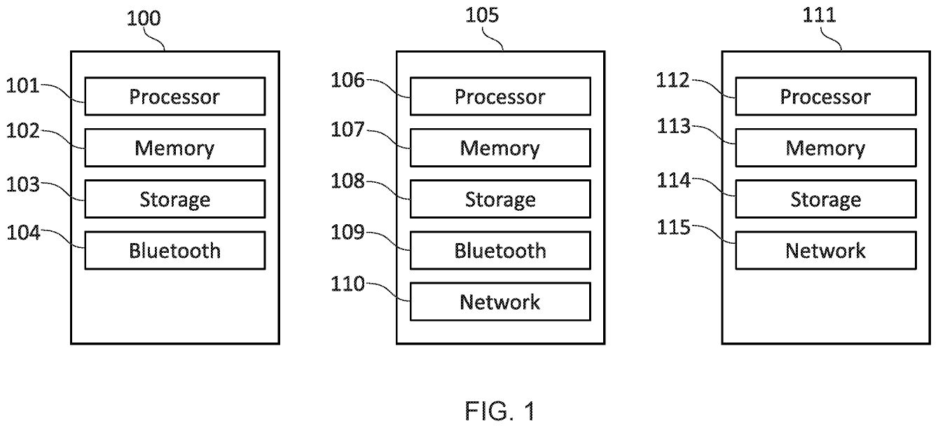

FIG. 1 shows a plurality of data processing apparatuses according to an embodiment. It shows a communication apparatus (device) 100 (e.g. a sensor deployed in an environment), a gateway apparatus (device) 105 and network service apparatus (device) 111.

The communication apparatus 100 comprises a processor 101 for executing electronic instructions, a memory 102 for storing the electronic instructions to be executed and electronic input and output information associated with the electronic instructions, a storage medium 103 (e.g. a hard disk drive, solid state drive, or FLASH storage) for long term storage of information and a Bluetooth® communication interface 104 for sending electronic information to and/or receiving electronic information from one or more other apparatuses using Bluetooth Low Energy. Each of the processor 101, memory 102, storage medium 103 and Bluetooth communication interface 104 are implemented using appropriate circuitry, for example. The processor 101 controls the operation of each of the memory 102, storage medium 103 and Bluetooth communication interface 104.

The gateway apparatus 100 comprises a processor 106 for executing electronic instructions, a memory 107 for storing the electronic instructions to be executed and electronic input and output information associated with the electronic instructions, a storage medium 108 (e.g. a hard disk drive, solid state drive or FLASH storage) for long term storage of information, a Bluetooth communication interface 109 for sending electronic information to and/or receiving electronic information from one or more other apparatuses using Bluetooth Low Energy and a network communication interface 110 for sending electronic information to and/or receiving electronic information from one or more other apparatuses over a telecommunications network (for example a local area network (LAN) or wide area network (WAN) such as the internet). Each of the processor 106, memory 107, storage medium 108, Bluetooth communication interface 109 and network communication interface 110 are implemented using appropriate circuitry, for example. The processor 106 controls the operation of each of the memory 107, storage medium 108, Bluetooth communication interface 109 and network communication interface 110.

The network service apparatus 111 comprises a processor 112 for executing electronic instructions, a memory 113 for storing the electronic instructions to be executed and electronic input and output information associated with the electronic instructions, a storage medium 114 (e.g. a hard disk drive, solid state drive or FLASH storage) for long term storage of information and a network communication interface 115 for sending electronic information to and/or receiving electronic information from one or more other apparatuses over a telecommunications network (for example a local area network (LAN) or wide area network (WAN) such as the internet). Each of the processor 112, memory 113, storage medium 114 and network communication interface 115 are implemented using appropriate circuitry, for example. The processor 112 controls the operation of each of the memory 113, storage medium 114 and network communication interface 115. The network service apparatus 111 may be comprised of a set of one or more data processing apparatuses providing a cloud-hosted service, for example.

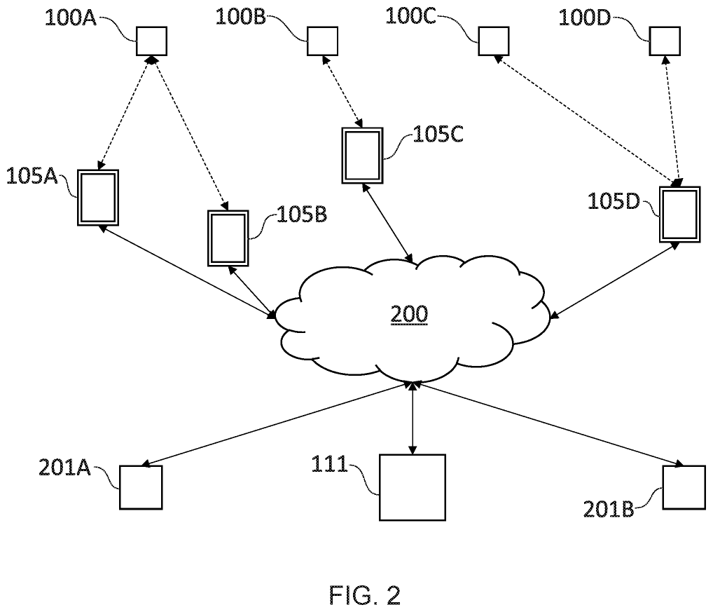

FIG. 2 shows a network (system) according to an embodiment. The network allows a plurality of communication apparatuses 100A-D (each having the configuration of communication apparatus 100 in FIG. 1) to communicate with a 3^{rd} party service hosted on a telecommunications network 200. Two 3^{rd} party services are provided in the example of FIG. 2, each of which are hosted on a respective 3^{rd} party server 201A and 201B connected to the network 200. In reality, there may be different numbers of 3^{rd} party services and/or third party servers. Electronic information is transmitted between each communication apparatus 100A-D and one of the 3^{rd} party servers 201A and 201B over the network 200 via one of the gateway apparatuses 105A-D (each having the configuration of communication apparatus 105 in FIG. 1) and network service apparatus 111 (having the configuration of network service apparatus 111 in FIG. 1). The 3^{rd} party servers 201A and 201B are conventional servers capable of providing a conventional web service, in this example.

In order for each communication device 101A-D to transmit electronic information to and/or receive electronic information from one of the 3^{rd} party servers 201A or 201B, a Bluetooth Low Energy connection is established with one of the gateway apparatuses 105A-D. Specifically, a gateway apparatus establishes such a connection with one or more communication devices in response to detecting a specific type of Bluetooth Low Energy advertising packet from those communication devices. This is described as a “Type A advertising packet” and is explained below.

In this example, gateway apparatus 105A and gateway apparatus 105B each receive a Bluetooth Low Energy advertising packet from communication device 100A (e.g. because they are both in range of communication device 100A). One of them then establishes a Bluetooth Low Energy connection with the communication device 100A. If both gateway apparatuses 105A and 105B attempt to establish a connection with the communication device 100A, the communication device 100A will accept a connection from only one of them (for example, the one which attempts to establish a connection first). Gateway apparatus 105C receives a Bluetooth Low Energy advertising packet from communication device 100B and then establishes a Bluetooth Low Energy connection with communication apparatus 100B. Gateway apparatus 105D receives a Bluetooth Low Energy advertising packet from communication devices 100C and 100D and establishes a Bluetooth Low Energy connection with each of them.

Each gateway apparatus 105A-D may be a dedicated gateway apparatus for routing electronic information between the telecommunications network 200 and communication devices 100A-D. Alternatively, one or more of the gateway apparatuses 105A-D may be a general purpose information processing apparatus such as a mobile phone (in particular, a smartphone), tablet computer or personal computer which has been configured through suitable programming to act as a gateway. In one example, the gateway apparatus 105A-D is a smartphone configured to operate as a gateway apparatus by way of a downloadable smartphone software application (app). As will be explained, a Bluetooth Low Energy connection is established between a communication device and a gateway apparatus each time the communication device wishes to transmit electronic information over the network 200. Once the transmission of electronic information is complete, the Bluetooth Low Energy connection may be terminated. The next time the communication device wishes to transmit electronic information over the network 200, a new Bluetooth Low Energy connection is established with a gateway apparatus. This may be the same gateway apparatus (e.g. if the gateway apparatus is still operational at the same location relative to the communication device and no other gateway apparatus has come within range) or a different one (e.g. if the original gateway apparatus is no longer operational (e.g. since its battery is depleted) or has moved out of range but another operational gateway apparatus is now within range). The communication device is thus provided with improved flexibility in the gateway apparatus it uses to transmit electronic information over the network 200. Furthermore, if existing devices such as smartphones are used as gateway apparatuses, no additional network infrastructure is required.

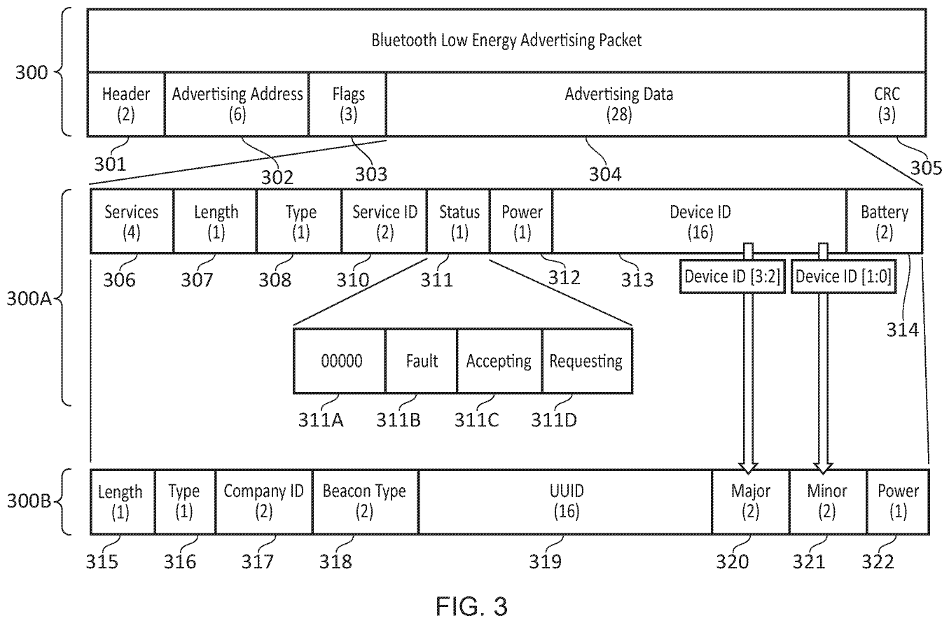

FIG. 3 shows example Bluetooth Low Energy advertising packets transmitted by each communication device 100A-D to enable transmission of electronic information between the communication device and network 200.

FIG. 3 shows a generic Bluetooth Low Energy advertising packet 300. Such advertising packets are known and are described in [1], for example. In summary, a Bluetooth Low Energy advertising packet comprises a header portion 301 (2 bytes), advertising address portion 302 (6 bytes), flags portion 303 (3 bytes), advertising data portion 304 (28 bytes) and a cyclic redundancy check CRC portion 305 (3 bytes). The advertising packet 300 also comprises a preamble and access address before the header (although these are not shown).

FIG. 3 shows a first specific configuration 300A of the Bluetooth Low Energy advertising packet 300. This is referred to as a Type A advertising packet. The advertising data of the Type A advertising packet comprises standard portions (present in Bluetooth Low Energy service advertising packets) and custom portions (customised portions which enable the functionality of the present technique). The standard portions include a services portion 306 (4 bytes), a length portion 307 (1 byte), a type portion 308 (1 byte) and a service ID 310 (2 bytes). The custom portions include a status portion 311 (1 byte), a power portion 312 (1 byte), device ID 313 (16 bytes) and a battery portion 314 (2 bytes). The status portion 311 comprises a number of sub-portions, including a blank sub-portion 311A (containing 5 bits all set to zero), a fault sub-portion 311B (1 bit), an accepting sub-portion 311C (1 bit) and a requesting sub-portion 311D (1 bit).

The requesting sub-portion contains a 0 when the communication device is not requesting a connection from one of the gateway apparatuses 105A-D and a 1 when the communication device is requesting a connection from one of the gateway apparatuses 105A-D (or vice versa).

The accepting sub-portion contains a 0 when the communication device is not able to accept a connection from one of the gateway apparatuses 105A-D and a 1 when the communication device is able to accept a connection from one of the gateway apparatuses 105A-D (or vice versa). This allows the communication device to accept unsolicited connection requests from a gateway apparatus (that is, connection requests which the communication device has not specifically requested) and thus enables improved functionality for the communication devices and gateway apparatuses. In an example, a gateway apparatus will only establish an unsolicited connection with a communication apparatus if the communication apparatus indicates this is acceptable using the accepting sub-portion.

The fault sub-portion contains a 0 when there is no fault with the communication device 100A-D and a 1 when there is a fault with the communication device (or vice versa). This allows the network service apparatus 111 to quickly and easily determine if the communication device has a fault.

The device ID is an identifier which uniquely identifies the communication device transmitting the Type A advertising packet. This is used by the network service apparatus 111 to determine a 3^{rd} party service with which the communication device is associated. In an example, this association is implemented by each 3^{rd} party service being associated with one or more unique network IDs. The device ID of each communication device is, in turn, associated with one of these network IDs. Information indicating the 3^{rd} party service associated with each network ID and the device ID associated with each network ID is stored in a database accessible to the network service apparatus 111 (e.g. stored in storage medium 114). This allows the network service apparatus 111 to determine which 3^{rd} party service each communication device is associated with based on the device ID.

The battery portion indicates the amount of energy stored in a battery of the communication device, thereby allowing the network service apparatus 111 to quickly and easily determine the battery status of the communication device.

The power portion indicates a measure of the power of signals from the communication device (e.g. received signal strength indicator, RSSI) at a known distance from the communication device. This allows the distance of a receiver of the signals from the communication device to then be estimated based on the measured signal power.

FIG. 3 shows a second specific configuration 300B of the Bluetooth Low Energy advertising packet 300. This is referred to as a Type B advertising packet. The advertising data of the Type B advertising packet comprises a length portion 315 (1 byte), a type portion 316 (1 byte), a company ID 317 (2 bytes), a beacon type portion 318 (2 bytes), a universal unique identifier 319 (UUID-16 bytes), a major portion 320 (2 bytes) comprising a major identifier, a minor portion 321 (2 bytes) comprising a minor identifier and a power portion 322 (1 byte). In an example, the Type B advertising packet is an iBeacon® advertising packet and the portions 315-322 are portions present in iBeacon advertising packets as standard. The Type B advertising packet comprises a first identifier and a second identifier. In this example, the first identifier is the UUID and the second identifier is the combination of major and minor identifiers (so, for example, the second identifier takes the form [major identifier, minor identifier]). However, the second identifier may be the major identifier only or the minor identifier only, for example. The first identifier (e.g. UUID) is a predetermined identifier associated with the provider of the network service apparatus 111 such that, upon detection of the first identifier in a Type B advertising packet by a gateway apparatus, the gateway apparatus enters a mode to detect Type A advertising packets. There may be multiple predetermined first identifiers associated with the provider of the network service apparatus 111. This allows the gateway apparatus to initially operate in a first mode (e.g. a lower power mode) in which only Type B advertising packets are detectable. When a communication device wishes for a Type A advertising packet to be detected (and therefore for a connection with a gateway apparatus to be established), it therefore first transmits a Type B advertising packet comprising the first identifier. Detection of this by the gateway apparatus causes the gateway apparatus to switch to a second mode (e.g. higher power mode) in which the subsequently detected Type A advertising packet is detectable. When the first mode is a lower power mode and the second mode is a higher power mode, this helps reduce gateway power consumption.

The switching of the gateway apparatus from the first mode to the second mode may be temporary. This is to help further reduce gateway power consumption, for example. For instance, upon detecting the first identifier in a Type B advertising packet, the gateway apparatus may transition to and remain in the second mode (allowing it to establish a connection in response to received Type A advertising packets) for a first predetermined time period (e.g. 10, 20 or 30 seconds) before reverting back to the first mode (in which received Type A advertising packets are ignored). Furthermore, after the switch from the first mode to the second mode (and subsequent return to the first mode), the gateway apparatus may not perform any further first to second mode transitions until a further Type B advertising packet comprising the first identifier is not detected by the gateway apparatus for a second predetermined time period (e.g. 10, 20 or 30 seconds).

Although this helps reduce the power consumption of the gateway apparatus, a further consequence of this is that, if the gateway apparatus continuously remains in range of communication devices transmitting further Type B advertising packets comprising the first identifier after the initial transition from the first mode to the second mode, it will revert back to the first mode after the first predetermined time period and will not be able to transition again from the first mode to the second mode. Communication devices wishing for a connection to be established will therefore be ignored (since the gateway apparatus does not detect Type A advertising packets in the first mode).

To address this, the second identifier (e.g. major and/or minor identifier) of the Type B advertising packet transmitted by a communication apparatus is indicated by the Type A advertising packet of that communication apparatus. This means that, even though the gateway apparatus transitions from the first mode to the second mode only in response to detecting a Type B advertising packet with the first identifier (and thus does not record the second identifier), it is able to determine the second identifier from the subsequently received Type A advertising packet. Then, instead of detecting if no Type B advertising packet comprising the first identifier is received for the second predetermined time period in order to allow a further transition from the first mode to the second mode, it is configured to transition from the first mode to the second mode when it detects no Type B advertising packets comprising the second identifier for the second predetermined time period. A different second identifier may be allocated to each communication device in a given geographical region (unlike the first identifier, which may be common to all the communication devices). The gateway apparatus thus only needs to detect no Type B advertising packet transmitted by a single one of the communication devices (rather than all the communication devices allocated with the first identifier) for the second predetermined time period to be able to once again transition from the first mode to the second mode and thus once again be able to detect Type A advertising packets.

The use of first and second identifiers of the Type B advertising packets in this way enables any of a plurality of communication devices transmitting type B advertising packets comprising the first identifier to cause the gateway apparatus to initially transition from the first mode to the second mode. This allows the gateway apparatus to then act on received Type A advertising packets and hence establish a connection with one of the communication devices. Furthermore, when the communication device from which a Type A advertising packet was received stops transmitting Type B advertising packets (e.g. as may occur once a connection is established with the communication device and therefore the communication device knows it is being serviced), the gateway apparatus is able to determine when these specific Type B advertising packets are no longer being transmitted (because none will be detected for the second predetermined time period). The gateway apparatus knows this because the second identifier comprised in these specific Type B advertising packets is derivable from one of the Type A advertising packets it received. The gateway apparatus is then able to once again transition from the first mode to the second mode and thus receive further Type A advertising packets and establish further connections. This helps improve the availability of gateway apparatuses and hence the robustness of the network.

In the example of FIG. 3, respective portions of the device ID of the Type A advertising packet broadcast by a given communication device match the major and minor identifiers of the Type B advertising packet broadcast by that communication device. For instance, in FIG. 3, bytes [3:2] of the device ID of the Type A advertising packet correspond to the major identifier of the Type B advertising packet and bytes [1:0] of the device ID of the Type A advertising packet correspond to the minor identifier of the Type B advertising packet.

When the Type B advertising packet is an iBeacon advertising packet, one or more of the gateway apparatuses 105-D may be an Apple® iOS device. An app is installed on the iOS device which causes the iOS device to scan for Type A advertising packets in response to detecting an iBeacon packet comprising a UUID which has been associated with the provider of the network service apparatus 111 and in response to no longer detecting an iBeacon packet comprising a major and/or minor identifier indicated by a previously received Type A advertising packet.

Although, in the above description, the gateway apparatus 105 transitions from the first mode (where Type A advertising packets are not detected) to the second mode (where Type A advertising packets are detected) in response to detecting a Type B advertising packet with a particular first identifier (e.g. a particular UUID) and/or a particular second identifier indicated by a previously received Type A advertising packet (e.g. a particular major and/or minor identifier), this is only an example. More generally, the gateway apparatus is configured to transition from the first mode to the second mode in response to receiving or no longer receiving one or more of a set of Type B advertising packets. The set of Type B advertising packets is stored as a list in the memory 107 and/or storage medium 108 of the gateway apparatus and comprises one or more predetermined Type B advertising packets (e.g. those with a predetermined first identifier such as a predetermined UUID) and/or one or more Type B advertising packets configured based on one or more previously received Type A advertising packets (e.g. Type B advertising packets with a second identifier such as a major and/or minor identifier indicated by the device ID of a previously received Type A advertising packet). In other words, the gateway apparatus maintains a list of Type B advertising packets with a particular characteristic (e.g. those with a predetermined UUID or a major and/or minor identifier indicated by the device ID of a previously received Type A advertising packet) and the detection or non-detection of at least one Type B advertising packet in the list causes the gateway apparatus to transition from the first mode to the second mode. Non-detection comprises, for example, detection of no Type B advertising packet in the list for a predetermined time period (e.g. the second predetermined time period mentioned above).

Type B advertising packets may be added to the set defined in the gateway apparatus list in any other way. For example, Type B advertising packets with a particular first and/or second identifier (or any other characteristic) may be manually added to the list by entering relevant details via a user interface (not shown) of the gateway apparatus 105 (e.g. via a suitable user interface of an app when the gateway apparatus is a smartphone). In an example, each communication apparatus 100 periodically transmits a Type A advertising packet whether or not it is requesting a connection. The transmitted Type A advertising packet comprises information about the communication apparatus 100 (e.g. indicating the battery state via battery portion 314, whether or not there is a fault via fault sub-portion 311B, etc.) and, when no connection is being requested (as indicated by the requesting sub-portion 311D, for example), whether or not unsolicited connections are accepted by the communication apparatus (as indicated by the accepting sub-portion 311C, for example).

This allows any gateway apparatus 105 already in the second mode in which Type A advertising packets are detectable (e.g. because the gateway apparatus previously received or stopped receiving a Type B advertising packet in the set of Type B advertising packets) to receive up-to-date information about the communication apparatus and establish a connection with the communication apparatus (either upon request by the communication apparatus or of its own motion because the communication apparatus has indicated it is accepting unsolicited connections). The communication apparatus 100 will then only start transmitting Type B advertising packets with the Type A advertising packets (e.g. alternately transmitting Type A and Type B advertising packets) when it intends to request a connection using the Type A advertising packets.

This ensures a connection with any gateway apparatus in range can be established when the communication apparatus requests such a connection (since the Type B advertising packet will cause the gateway apparatus to transition from the first mode to the second mode if the gateway apparatus isn't already in the second mode). At the same time, power consumption of the communication apparatus can be reduced due to the need to transmit only Type A advertising packets when a connection is not being specifically requested. This therefore helps balance network flexibility and power efficiency.

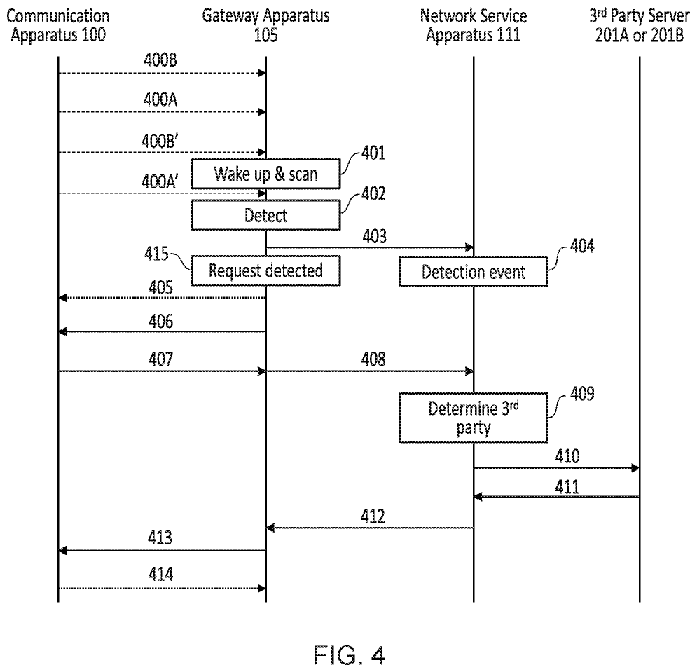

FIG. 4 shows an example electronic information transmission flow between a communication apparatus 100, gateway apparatus 105, the network service apparatus 111 and a 3^{rd} party server 201A or 201B, according to an embodiment.

The communication device 100 wishes to connect to the network 200 to send electronic information to the 3^{rd} party server. It therefore starts transmitting Bluetooth Low Energy advertising packets. In this particular example, it starts alternately transmitting Type B advertising packets (steps 400B, 400B′) and Type A advertising packets (steps 400A, 400A′). The first transmission of the Type B and Type A advertising packets (steps 400B, 400A) is not picked up by the gateway apparatus 100 (e.g. because the gateway apparatus is too far away). However, the second transmission of the Type B and Type A advertising packets (400B′, 400A′) is picked up by the gateway apparatus (e.g. because the communication device and/or gateway apparatus have moved closer to each other).

One or more repetitions of the transmission of each Type A and Type B advertising packet may be made as the Type A and Type B advertising packets are alternately transmitted (e.g. one Type A followed by one Type B, two Type As followed by two Type Bs, one Type A followed by two Type Bs, two Type As followed by one Type b, etc.).

At step 401, in response to the gateway apparatus detecting the Type B advertising packet at step 400B′ (comprising the UUID associated with the provider of the network service apparatus 111), the gateway apparatus enters a mode in which it scans for the Type A advertising packet. This may involve the gateway apparatus waking up from a lower power mode to a higher power mode, for example. At step 402, it therefore detects the Type A advertising packet transmitted at step 400A′.

At step 403, in response to detecting the Type A advertising packet at step 402, at least a portion of the information comprised in the Type A advertising packet is transmitted to the network service apparatus 111 over the network 200. This information includes, for example, the device ID, the battery level of the communication device 100 (determined from the battery portion of the Type A advertising packet) and whether or not the communication device 100 has a fault (determined from the fault portion of the Type A advertising packet). Further information, such as information indicating a location (at least approximately) of the communication device 100, may also be transmitted to the network service apparatus 111 at step 403. In one example, when the gateway apparatus 105 comprises location determination functionality (e.g. global navigation satellite system (GNSS) circuitry (not shown) controlled by the processor 106), the location of the gateway apparatus 105 is transmitted to the network service apparatus 111 and this is deemed to be the location of the communication device 100. This enables a location of the communication device 100 to be determined (at least approximately) even if the communication device 100 itself does not comprise location determination functionality. Thus, information derivable upon receiving a Type A advertising packet may indicate one of more characteristics of the communication device 100 sending it. This information may be directly indicated by the Type A advertising packet (e.g. battery level or whether the communication device has a fault) or derivable indirectly (e.g. the approximate location of the communication apparatus based on the device ID of the communication apparatus and the determined location of the gateway apparatus).

The information transmitted at step 403 is recorded at step 404 as a detection event by the network service apparatus 111 (e.g. in the storage medium 114).

Also in response to detecting the Type A advertising packet at step 402, the gateway apparatus 105 determines whether the communication device 100 is requesting a connection. This is determined based on the requesting portion of the Type A advertising packet. In this example, the requesting portion of the Type A advertising packet received at step 400A′ indicates the communication device is requesting a connection. This is detected at step 415.

At step 405, the gateway apparatus 105 establishes a Bluetooth Low Energy connection with the communication apparatus 100. For improved data security, at step 406, after establishment of the Bluetooth Low Energy connection, the gateway apparatus 105 may complete suitable security protocol(s) with the communication apparatus 100. For example, digitally signed data may be exchanged between the gateway apparatus and communication apparatus (so the gateway apparatus and communication apparatus are able to authenticate each other) and/or an encrypted connection may be established between the gateway apparatus and communication apparatus. Any suitable security protocol(s) may be completed based on techniques known in the art and, for example, the security requirements of the 3^{rd} party service looking to receive information from the communication apparatus 100. The security protocol(s) may be done at the application layer, for example.

On establishment of the Bluetooth Low Energy connection, the communication apparatus 100 transmits electronic information to the gateway apparatus 105 at step 407. This may occur concurrently with at least a portion of the completion of the security protocol(s) completed at step 406 (e.g. if a digital signature is used for authentication of the communication apparatus, this may be a digital signature of the information sent at step 407). This is then routed to the network service apparatus 111 at step 408. The electronic information can be any information generated or received by the communication apparatus 100. For example, the communication apparatus may comprise or be connected to one or more sensors (not shown) and the electronic information may indicate a measurement of the one or more sensors.

The electronic information transmitted at step 407 and 408 comprises the device ID. This allows the network service apparatus 111 to determine the 3^{rd} party service at step 409 (based on the network ID associated with the device ID and the 3^{rd} party service associated with the network ID). The electronic information is then forwarded to the relevant 3^{rd} party server 201A or 201B at step 410.

In this example, the electronic information transmitted at steps 407, 408 and 410 indicates a request. For example, if the electronic information indicates one or more sensor measurements, this information may be sent as part of the request together with information requesting a response indicating that the 3^{rd} party server 201A and 201B has successfully received and stored the one or more sensor measurements. The response is transmitted from the 3^{rd} party server to the network server apparatus 111 at step 411, back to the gateway apparatus 105 at step 412 and back to the communication apparatus 100 at step 413. Once the response is successfully received by the communication apparatus, the communication apparatus closes the established Bluetooth Low Energy connection at step 414.

The receiving of the Type B advertising packet at steps 400B and 400B′ is optional. For example, the gateway apparatus 105 may, instead, only detect Type A advertising packets (e.g. because it ignores Type B advertising packets or the communication apparatus 100 only transmit Type A advertising packets) and the gateway apparatus 105 may therefore be configured to constantly scan for the Type A advertising packets. This helps reduce any latency associated with the gateway apparatus 105 first detecting a Type B advertising packet and switching mode before being able to detect the Type A advertising packet. On the other hand, by including use of the Type B advertising packet, the power consumption at the gateway apparatus 105 may be reduced since, until a Type B advertising packet is received (causing the gateway apparatus to wake up), the gateway apparatus may operate in a lower power mode. This is especially advantageous when the gateway apparatus is a portable apparatus such as a smartphone which is powered with a battery. It will be appreciated that the use of a Type B advertising packet may or may not be configured based on the requirements of the system (e.g. whether lower latency or lower gateway apparatus power consumption is to take priority).

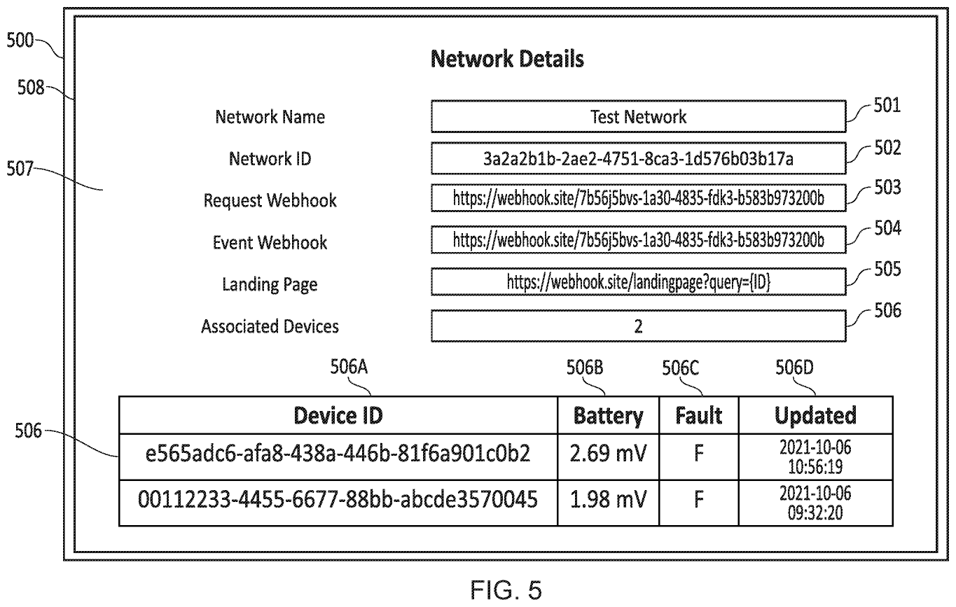

FIG. 5 shows an example configuration screen 507 of the network service apparatus 111. The configuration screen 507 is displayed on an electronic display 508 of an information processing apparatus 500 (e.g. a personal computer, tablet or smartphone) connected to the network service apparatus 111 over the network 200, for example. In an example, the network service apparatus 111 is a server and the configuration screen 507 is accessed by an owner of a 3^{rd} party service hosted on one of the 3^{rd} party servers 201A or 201B logging on to a web service hosted by the network service apparatus 111. Each owner of a 3^{rd} party service is able to log on to the network service apparatus 111 in this way by registering with the network service apparatus 111 in advance and choosing a unique identifier (e.g. username) and authentication information (e.g. a password or biometric information such as a fingerprint or facial profile) as their login information. Once logged on, the 3^{rd} party service owner is able to create one or more networks (each with a respective unique network ID with which the unique device ID of one or more communication devices can be associated).

The configuration screen 507 shows example configuration information of one network associated with the current 3^{rd} party service owner who is logged in. Each 3^{rd} party service owner may create and maintain multiple networks in this way (with the configuration screen for each network being displayed in response to selecting the network they wish to configure using a selectable menu or the like, for example). This example configuration information includes a network name, network ID, a request webhook, an event webhook, a landing page and the number of associated devices. A table 506 showing the devices registered to the network is also displayed.

The network name is entered by the user into the text field 501 (using e.g. a physical or virtual keyboard, speech-to-text interface or the like). In this example, the network name is set as “Test Network”. By choosing a unique network name for each network they maintain, each 3^{rd} party service owner is able to easily distinguish each of their networks from each other.

The network ID is unique for each network managed by the network service apparatus 111. It is automatically generated by the network service apparatus 111 for a network when that network is created and displayed in the text field 502. In this example, the network ID takes the form of a 128 bit universally unique identifier UUID. The network ID is associated with the unique ID the 3^{rd} party service owner uses to log on to the web service hosted by the network service apparatus 111.

The request webhook is entered by the user into the text field 503. This is a uniform resource locator (URL) which acts as an address of the 3^{rd} party server 201A or 201B to which requests received from a communication device 100 associated with the network are transmitted (see e.g. step 410).

The event webhook is optionally entered by the user into the text field 504. This is a uniform resource locator (URL) which acts as an address of the 3^{rd} party server 201A or 201B to which information included in the Type A advertising packet (e.g. battery status, whether or not a fault is detected, etc.) received from a communication device 100 associated with the network may be transmitted. This allows information about the communication device to be ascertained by the relevant 3^{rd} party service even if a Bluetooth Low Energy connection is not requested and established. This is useful, for example, to allow the 3^{rd} party service to monitor one or more characteristics (e.g. battery status, whether or not a fault is detected, etc.) of its associated communication device(s) in a power and network efficient way. In this example, the request webhook and event webhook are the same. However, they may be different.

The landing page is optionally entered by the user into the text field 505. This enables additional functionality associated with a communication device 100 to be implemented. For example, the communication device 100 may have a Quick Response (QR) code (not shown) located on it or NFC circuitry (not shown) for exchanging NFC signals with another NFC-enabled data processing apparatus (e.g. a smartphone). The QR code or NFC signal indicates both the network service apparatus 111 (e.g. through a URL of the web service hosted by the network service apparatus 111) and device ID of the communication device 100. In response to receiving a request at the URL comprising the device ID from a data processing apparatus (e.g. a smartphone) which has detected the QR code or NFC signal, the network service apparatus 111 implements a redirect to the URL indicated in text field 505. This URL may be associated with the 3^{rd} party service, for example, thereby allowing information about the network and/or communication device (again, based on the device ID) to be provided quickly and efficiently to a user in response to scanning of the QR code or NFC signal.

The number of associated devices indicates the total number of communication devices registered with this particular network. In this case, there are two devices (hence the number “2” appears in the text field 506). Information indicating each registered device is also displayed in the table 506. Here, each device is identified with its unique device ID (also a 128 bit UUID in this example) in column 506A. Additional information is also provided. In this example, the additional information comprises information obtained from Type A advertising packets transmitted by each communication device. Specifically, column 506B shows the battery level (in mV, based on the battery portion of the Type B advertising packet) and column 506C shows whether or not a fault has been detected (with “F” indicating false (i.e. there is no fault) and “T” indicating true (i.e. there is a fault, based on the fault sub-portion of the Type A advertising packet). In this example, the additional information also comprises (in column 506D) the date and time at which contact was last received from each communication device. This may be, for example, the time at which the latest Type A advertising packet was detected.

It will be appreciated that, in reality, a much larger number of communication devices may be associated with the network and identified in table 506 and a much larger number of information types may be present in table 506. The information types presented in the table may be configurable at the network service apparatus 111 by the 3^{rd} party service owner (e.g. via a further configuration screen (not shown) displayed on the electronic display 508) and may depend on the functionality of the communication devices 100 concerned.

A device ID may be allocated to each respective communication device 100 in any suitable way, as long as each device ID is unique to enable the network (indicated, in turn, by a unique network ID) to be unambiguously identified based on the device ID. In an example, each device ID and network ID is a 128-bit universally unique identifier (UUID), thereby ensuring each device ID and network ID is globally unique.

Communication devices 100 such as sensors may be added to a network using any suitable technique. Added communication devices appear as additional devices in the table 506 of the configuration screen 507. In an example, the device ID of a communication device is added manually by the user (e.g. by entering the device ID in a text field (not shown) provided on the configuration screen 507). In another example, the communication device 100 may have a QR code (not shown) located on it or NFC circuitry (not shown) for exchanging NFC signals with another NFC-enabled data processing apparatus (e.g. a smartphone). The QR code or NFC signal indicates the device ID of the communication device 100. The web service of the network service apparatus 111 may then be run on a device capable of scanning the QR code or NFC signal (e.g. on a browser of a smartphone) and, in response to receiving the device ID via the QR code or NFC signal, the web service adds the communication device to the table 506 (thereby associated the device ID with the network ID). Electronic information received from that particular communication device is then routed to the 3^{rd} party server hosting the 3^{rd} party service via, for example, the request and/or event webhooks. The use of a QR code or NFC signal in this way allows communication devices (each with a unique device ID) to be quickly and efficiently associated with a particular network (with a unique network ID) and with a 3^{rd} party service (based on the request and/or event webhooks associated with the network ID). Communication devices 100 may also be associated with a network ID using, for example, Bluetooth scanning. In this case, for example, the data processing apparatus (e.g. smartphone or personal computer) on which the web service of the network service apparatus 111 is run conducts a Bluetooth scan whilst the communication devices each output a Bluetooth signal indicating their device ID. In an example, the Bluetooth signal is the Type B advertising packet. The data processing apparatus then associates each detected device ID with the network ID of the network being configured. This allows multiple communication devices to be associated with a particular network ID quickly and easily.

The present technique thus allows any party hosting a web service on a web server (e.g. 3^{rd} party server 201A or 201B) to establish a network of communication devices 100 configured to communicate with the web service. No infrastructure is required other than the communication devices 100 themselves and one or more data processing apparatuses (e.g. smartphones with a suitable app installed) configured to act as gateway apparatuses 105. This is particularly beneficial in an environment in which, for example, there are many such gateway apparatuses 105 in the vicinity of the communication devices 100 (e.g. a factory comprising many communication devices for monitoring factory machine performance and in which most factory workers carry a smartphone, a shopping centre comprising many communication devices for monitoring footfall and in which most shoppers carry a smartphone or a stadium comprising many communication devices for monitoring crowd safety and in which most people in the crowd carry a smartphone). This allows reliable and efficient communication device networks to be set up by any party cheaply and quickly.

In the above examples, requests and/or events are reported to a 3^{rd} party server (e.g. via a webhook). In another example, the network service apparatus 111 itself may receive requests and/or events and, in the case of requests, issue responses. For example, the network service apparatus 111 itself may operate a web service which exchanges information with one or more communication devices 100 in the way described. Here, the described functionality of both the network service apparatus 111 and 3^{rd} party server 201A or 201B is carried out by a single data processing apparatus.

In the above examples, the network service apparatus 111 looks up a device ID to determine the 3^{rd} party service with which a communication device 100 is associated and routes information to the relevant 3^{rd} party service. In another example, the gateway apparatus itself looks up the device ID and routes the information to the relevant 3^{rd} party service. In this case, the storage medium 108 of the gateway apparatus 105 (rather than the storage medium 114 of the network service apparatus 111) stores a database associating the device ID with the relevant network ID and associating the network ID with the relevant 3^{rd} party service, for example. The database may also be stored at another location (not shown) on the network 200, for example. Here, the described functionality of both the gateway apparatus 105 and network service apparatus 111 is carried out by a single data processing apparatus.

In an example when there is a plurality of communication apparatuses 100 physically close to one another and a Type B advertising packet is used, only a portion of the communication apparatuses may transmit the Type B advertising packet. This causes any nearby gateway apparatus 105 to switch to the mode for scanning for the Type A advertising packet. All the communication apparatuses may then transmit the Type A advertising packet (which are then detected by the nearby gateway apparatus 105). This enables the benefits of using the Type A advertising packet but allows the complexity of a portion of the communication apparatuses 100 (i.e. those which transmit only the Type A advertising packet) to be reduced. Lower complexity communication apparatuses are desirable due to their lower cost and lower power consumption, for example.

Mention of “Bluetooth® Low Energy” in this specification refers to any version enabling Bluetooth Low Energy advertising packets and Bluetooth Low Energy connection establishment according to the embodiments described. This includes the current version of Bluetooth Low Energy at the effective filing date of this patent/patent application, any previous version of Bluetooth Low Energy in which these features were included and any future version of Bluetooth Low Energy in which these features are retained. A non-limiting example of Bluetooth Low Energy usable with the present technique is that described in [1].

Mention of “iBeacon” in this specification refers to any version enabling iBeacon advertising packets comprising a UUID, major identifier and minor identifier and which enable a gateway apparatus (in particular, an Apple IOS apparatus) to enter a mode to detect Type B advertising packets according to the embodiments described. This includes the current version of iBeacon at the effective filing date of this patent/patent application, any previous version of iBeacon in which these features were included and any future version of iBeacon in which these features are retained. A non-limiting example of iBeacon usable with the present technique is that described in [2].

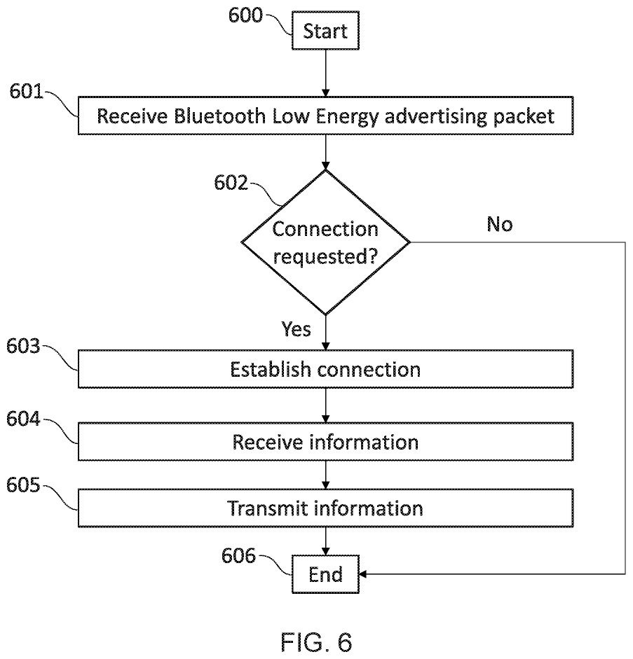

FIG. 6 shows a first method according to an embodiment. The method is implemented by the gateway apparatus 105.

The method starts at step 600.

At step 601, the processor 106 controls the Bluetooth communication interface 109 to wirelessly receive, in a Bluetooth Low Energy advertising packet (e.g. Type A advertising packet 300A), an identifier of a communication apparatus 100 (e.g. device ID 313) and an indicator (e.g. requesting sub-portion 311D) of whether the communication apparatus is requesting a wireless connection with a gateway apparatus. This is exemplified in step 400A′ of FIG. 4, for example.

At step 602, the processor 106 determines whether the Bluetooth Low Energy advertising packet indicates the communication apparatus 100 is requesting a wireless connection with a gateway apparatus (e.g. whether the requesting sub-portion 311D contains a 0 or a 1).

If a wireless connection is not requested, the method ends at step 606.

If a wireless connection is requested, the method proceeds to step 603. At step 603, the processor 106 controls the Bluetooth communication interface 109 to establish a wireless connection with the communication apparatus 100 (via the Bluetooth communication interface 104). This is exemplified in steps 415, 405 and 406 of FIG. 4, for example.

At step 604, the processor 106 controls the Bluetooth communication interface 109 to receive, via the established wireless connection, information from the communication apparatus 100 associated with the identifier of the communication apparatus (e.g. information indicating a sensor measurement of the communication apparatus). This is exemplified in step 407 of FIG. 4, for example.

At step 605, the processor 106 controls the network communication interface 110 to transmit the information received at step 604 to a web service (e.g. to a 3^{rd} party server 201A or 201B hosting the web service). This is exemplified in steps 408 and 410 of FIG. 4, for example. In this particular example, the information is transmitted to the web service via the network service apparatus 111.

The method ends at step 606.

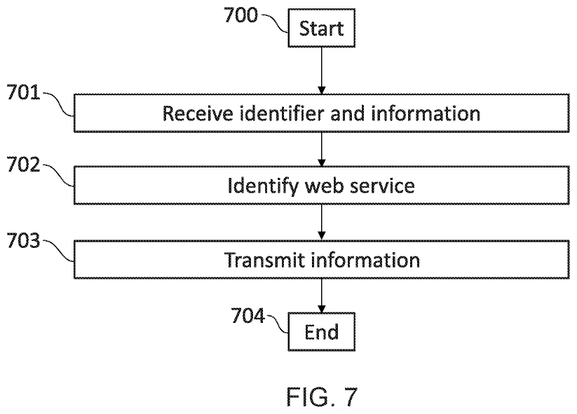

FIG. 7 shows a second method according to an embodiment. The method is implemented by the network service apparatus 111.

The method starts at step 700.

At step 701, the processor 112 controls the network communication interface 115 to receive, via a gateway apparatus 105, an identifier of a communication apparatus 100 (e.g. device ID 313) and information from the communication apparatus (e.g. information indicating a sensor measurement of the communication apparatus). This is exemplified in step 408 of FIG. 4, for example. The identifier of the communication apparatus is transmitted to the gateway apparatus by the communication apparatus in a Bluetooth Low Energy advertising packet (e.g. Type A advertising packet 300A) and the information from the communication apparatus is transmitted to the gateway apparatus by the communication apparatus via a wireless connection established with the gateway apparatus in response to an indicator (requesting sub-portion 311D) in the Bluetooth Low Energy advertising packet indicating a wireless connection with a gateway apparatus is requested by the communication apparatus.

At step 702, the processor 112 identifies a web service associated with the identifier of the communication apparatus. This is achieved by looking up the communication apparatus identifier in a database stored in the storage medium 114 associating the communication apparatus identifier with a network identifier and associating the network identifier with the web service, for example. This is exemplified in step 409 of FIG. 4, for example.

At step 703, the processor 112 controls the network communication interface 115 to transmit the received information to the identified web service (e.g. to a 3^{rd} party server 201A or 201B hosting the web service). This is exemplified in step 410 of FIG. 4, for example.

The method ends at step 704.

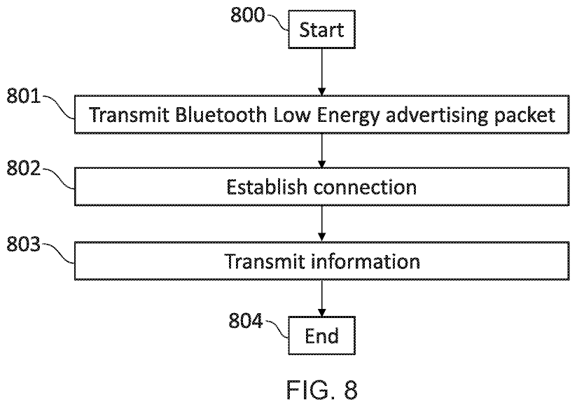

FIG. 8 shows a third method according to an embodiment. The method is implemented by the communication apparatus 100.

The method starts at step 800.

At step 801, the processor 101 controls the Bluetooth communication interface 104 to wirelessly transmit, in a Bluetooth Low Energy advertising packet (e.g. Type A advertising packet 300A), an identifier of the communication apparatus (e.g. device ID 313) and an indicator (e.g. requesting sub-portion 311D) of whether the communication apparatus is requesting a wireless connection with a gateway apparatus. This is exemplified in step 400A′ of FIG. 4, for example.

At step 802, the processor 101 controls the Bluetooth communication interface 104 to establish, in response to receiving a wireless connection request from a gateway apparatus 105, a wireless connection with the gateway apparatus (via the Bluetooth communication interface 109), the wireless connection request being received from the gateway apparatus when the Bluetooth Low Energy advertising packet indicates the communication apparatus is requesting a wireless connection with a gateway apparatus. This is exemplified in steps 415, 405 and 406 of FIG. 4, for example.

At step 803, the processor 101 controls the Bluetooth communication interface 104 to transmit, via the established wireless connection, information associated with the identifier of the communication apparatus (e.g. information indicating a sensor measurement of the communication apparatus 100) to the gateway apparatus 105.

The method ends at step 804.

Embodiment(s) of the present disclosure are defined by the following numbered clauses:
1. A gateway apparatus comprising circuitry configured to:
   wirelessly receive, in a Bluetooth Low Energy advertising packet, an identifier of a communication apparatus and an indicator of whether the communication apparatus is requesting a wireless connection with a gateway apparatus;
   establish, in response to the Bluetooth Low Energy advertising packet indicating the communication apparatus is requesting a wireless connection with a gateway apparatus, a wireless connection with the communication apparatus;
   receive, via the established wireless connection, information from the communication apparatus associated with the identifier of the communication apparatus; and
   transmit the received information to a web service.
2. A gateway apparatus according to clause 1, wherein the web service is associated with the identifier of the communication apparatus.
3. A gateway apparatus according to clause 1 or 2, wherein:
   the Bluetooth Low Energy advertising packet is a first type of Bluetooth Low Energy advertising packet; and
   the circuitry is configured to enter a mode to wirelessly receive the first type of Bluetooth Low Energy advertising packet in response to receiving or no longer receiving one or more of a set of a second type of Bluetooth Low Energy advertising packet.
4. A gateway apparatus according to clause 3, wherein a portion of the set of the second type of Bluetooth Low Energy advertising packet is configured based on one or more previously received Bluetooth Low Energy advertising packets of the first type.
5. A gateway apparatus according to clause 4, wherein a portion of the set of the second type of Bluetooth Low Energy advertising packet is configured based on an identifier of a communication apparatus indicated by the one or more previously received Bluetooth Low Energy advertising packets of the first type.
6. A gateway apparatus according to any one of clauses 3 to 5, wherein the second type of Bluetooth Low Energy advertising packet is an iBeacon packet.
7. A gateway apparatus according to any one of clauses 1 to 6, wherein:
   the information received from the communication apparatus is a request; and
   the circuitry is configured to transmit, via the established wireless connection, a response to the request to the communication apparatus.
8. A gateway apparatus according to any one of clauses 1 to 7, wherein the Bluetooth Low Energy advertising packet comprises information from which a characteristic of the communication apparatus is derivable.
9. A gateway apparatus according to any one of clauses 1 to 8, wherein the circuitry is configured to transmit additional information with the received information to the web service.
10. A gateway apparatus according to clause 9, wherein the additional information comprises a location of the gateway apparatus.
11. A gateway apparatus according to any one of clauses 1 to 10, wherein the circuitry is configured to complete a security protocol to allow authentication and/or encryption of the information received from the communication apparatus via the established wireless connection.
12. A gateway apparatus according to any one of clauses 1 to 11, wherein:
   the Bluetooth Low Energy advertising packet comprises an indicator of whether the communication apparatus is accepting a wireless connection with a gateway apparatus; and
   in the absence of the communication apparatus requesting a wireless connection with a gateway apparatus, the circuitry is configured to establish a wireless connection with the communication apparatus only if the Bluetooth Low Energy advertising packet indicates the communication apparatus is accepting a wireless connection with a gateway apparatus.
13. A gateway apparatus according to any one of clauses 1 to 12, wherein the gateway apparatus is a smartphone.
14. A network service apparatus comprising circuitry configured to:
   receive, via a gateway apparatus, an identifier of a communication apparatus and information from the communication apparatus, the identifier of the communication apparatus being transmitted to the gateway apparatus by the communication apparatus in a Bluetooth Low Energy advertising packet and the information from the communication apparatus being transmitted to the gateway apparatus by the communication apparatus via a wireless connection established with the gateway apparatus in response to an indicator in the Bluetooth Low Energy advertising packet indicating a wireless connection with a gateway apparatus is requested by the communication apparatus;
   identify a web service associated with the identifier of the communication apparatus; and
   transmit the received information to the identified web service.
15. A network service apparatus according to clause 14, wherein the circuitry is configured to access a database associating an identifier of the identified web service with the identifier of the communication apparatus.
16. A network service apparatus according to clause 14 or 15, wherein:
   the information received from the communication apparatus is a request; and
   the circuitry is configured to receive, from the identified web service, a response to the request; and
   transmit the response to the request to the communication apparatus.
17. A network service apparatus according to any one of clauses 14 to 16, wherein the circuitry is configured to:
   receive, via the gateway apparatus, information indicating a characteristic of the communication apparatus, the information indicating the characteristic of the communication apparatus being derived by the gateway apparatus from information comprised in the Bluetooth Low Energy advertising packet transmitted to the gateway apparatus by the communication apparatus; and
   transmit the information indicating the characteristic of the communication apparatus to the identified web service.
18. A network service apparatus according to any one of clauses 14 to 17, wherein the circuitry is configured to:
   receive, from the gateway apparatus, additional information with the information received from the communication apparatus via the gateway apparatus; and
   transmit the additional information with the received information to the identified web service.
19. A network service apparatus according to clause 18, wherein the additional information comprises a location of the gateway apparatus.
20. A network service apparatus according to any one of clauses 14 to 19, wherein the information received via the gateway apparatus and transmitted to the identified web service is transmitted to the identified web service using a webhook.
21 A communication apparatus comprising circuitry configured to:
   wirelessly transmit, in a Bluetooth Low Energy advertising packet, an identifier of the communication apparatus and an indicator of whether the communication apparatus is requesting a wireless connection with a gateway apparatus;
   establish, in response to receiving a wireless connection request from a gateway apparatus, a wireless connection with the gateway apparatus, the wireless connection request being received from the gateway apparatus when the Bluetooth Low Energy advertising packet indicates the communication apparatus is requesting a wireless connection with a gateway apparatus; and
   transmit, via the established wireless connection, information associated with the identifier of the communication apparatus to the gateway apparatus.
22. A communication apparatus according to clause 21, wherein:
   the Bluetooth Low Energy advertising packet is a first type of Bluetooth Low Energy advertising packet; and
   the circuitry is configured to transmit a second type of Bluetooth Low Energy advertising packet for causing the gateway apparatus to enter a mode in which the first type of Bluetooth Low Energy advertising packet is receivable.
23. A communication apparatus according to clause 22, wherein the transmitted second type of Bluetooth Low Energy advertising packet is configured based on the transmitted first type of Bluetooth Low Energy advertising packet.
24. A communication apparatus according to clause 23, wherein the transmitted second type of Bluetooth Low Energy advertising packet is configured based on the identifier of the communication apparatus indicated by the transmitted first type of Bluetooth Low Energy advertising packet.
25. A communication apparatus according to any one of clauses 22 to 24, wherein the second type of Bluetooth Low Energy advertising packet is an iBeacon packet.
26. A communication apparatus according to any one of clauses 22 to 25, wherein the circuitry is configured to alternately transmit one or more repetitions of the first type of Bluetooth Low Energy advertising packet and one or more repetitions of the second type of Bluetooth Low Energy advertising packet.
27. A communication apparatus according to any one of clauses 22 to 26, wherein the circuitry is configured to transmit the second type of Bluetooth Low Energy advertising packet when the first type of Bluetooth Low Energy advertising indicates the communication apparatus is requesting a wireless connection with a gateway apparatus.
28. A communication apparatus according to any one of clauses 21 to 27, wherein:
   the information transmitted to the gateway apparatus is a request; and
   the circuitry is configured to receive, via the established wireless connection, a response to the request from the gateway apparatus.
29. A communication apparatus according to any one of clauses 21 to 28, wherein the Bluetooth Low Energy advertising packet comprises information from which a characteristic of the communication apparatus is derivable.
30. A communication apparatus according to any one of clauses 21 to 29, wherein:
   the Bluetooth Low Energy advertising packet comprises an indicator of whether the communication apparatus is accepting a wireless connection with a gateway apparatus; and
   in the absence of the communication apparatus requesting a wireless connection with a gateway apparatus, the circuitry is configured to establish a wireless connection with a gateway apparatus only if the Bluetooth Low Energy advertising packet indicates the communication apparatus is accepting a wireless connection with a gateway apparatus.
31. A method of controlling a gateway apparatus, the method comprising controlling the gateway apparatus to:
   wirelessly receive, in a Bluetooth Low Energy advertising packet, an identifier of a communication apparatus and an indicator of whether the communication apparatus is requesting a wireless connection with a gateway apparatus;
   establish, in response to the Bluetooth Low Energy advertising packet indicating the communication apparatus is requesting a wireless connection with a gateway apparatus, a wireless connection with the communication apparatus;
   receive, via the established wireless connection, information from the communication apparatus associated with the identifier of the communication apparatus; and
   transmit the received information to a web service.
32. A method of controlling a network service apparatus, the method comprising controlling the network service apparatus to:
   receive, via a gateway apparatus, an identifier of a communication apparatus and information from the communication apparatus, the identifier of the communication apparatus being transmitted to the gateway apparatus by the communication apparatus in a Bluetooth Low Energy advertising packet and the information from the communication apparatus being transmitted to the gateway apparatus by the communication apparatus via a wireless connection established with the gateway apparatus in response to an indicator in the Bluetooth Low Energy advertising packet indicating a wireless connection with a gateway apparatus is requested by the communication apparatus;
   identify a web service associated with the identifier of the communication apparatus; and
   transmit the received information to the identified web service.
33. A method of controlling a communication apparatus, the method comprising controlling the communication apparatus to:
   wirelessly transmit, in a Bluetooth Low Energy advertising packet, an identifier of the communication apparatus and an indicator of whether the communication apparatus is requesting a wireless connection with a gateway apparatus;
   establish, in response to receiving a wireless connection request from a gateway apparatus, a wireless connection with the gateway apparatus, the wireless connection request being received from the gateway apparatus when the Bluetooth Low Energy advertising packet indicates the communication apparatus is requesting a wireless connection with a gateway apparatus; and
   transmit, via the established wireless connection, information associated with the identifier of the communication apparatus to the gateway apparatus.
34. A program for controlling a computer to perform a method according to any one of clauses 31 to 33.
35. A storage medium storing a program according to clause 34.
36. A system comprising:
   a gateway apparatus according to clause 1;
   a network service apparatus according to clause 14; and
   a communication apparatus according to clause 21.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

### REFERENCES

[1] LINDH, Joakim Bluetooth low energy Beacons Texas Instruments Application Report SWRA274A—January 2015—Revised October 2015 https://www.ti.com/lit/an/swra475a/swra475a.pdf
[2] iBeacon-Apple Developer https://developer.apple.com/ibeacon/

1. A gateway apparatus comprising circuitry configured to:
wirelessly receive, in a Bluetooth Low Energy advertising packet, an identifier of a communication apparatus and an indicator of whether the communication apparatus is requesting a wireless connection with a gateway apparatus;
establish, in response to the Bluetooth Low Energy advertising packet indicating the communication apparatus is requesting a wireless connection with a gateway apparatus, a wireless connection with the communication apparatus;
receive, via the established wireless connection, information from the communication apparatus associated with the identifier of the communication apparatus; and
transmit the received information to a web service.

2. A gateway apparatus according to claim 1, wherein the web service is associated with the identifier of the communication apparatus.

3. A gateway apparatus according to claim 1, wherein:
the Bluetooth Low Energy advertising packet is a first type of Bluetooth Low Energy advertising packet; and
the circuitry is configured to enter a mode to wirelessly receive the first type of Bluetooth Low Energy advertising packet in response to receiving or no longer receiving one or more of a set of a second type of Bluetooth Low Energy advertising packet.

4. A gateway apparatus according to claim 3, wherein a portion of the set of the second type of Bluetooth Low Energy advertising packet is configured based on one or more previously received Bluetooth Low Energy advertising packets of the first type.

5. A gateway apparatus according to claim 4, wherein a portion of the set of the second type of Bluetooth Low Energy advertising packet is configured based on an identifier of a communication apparatus indicated by the one or more previously received Bluetooth Low Energy advertising packets of the first type.

6. A gateway apparatus according to claim 3, wherein the second type of Bluetooth Low Energy advertising packet is an iBeacon packet.

7. A gateway apparatus according to claim 1, wherein:
the information received from the communication apparatus is a request; and
the circuitry is configured to transmit, via the established wireless connection, a response to the request to the communication apparatus.

8. A gateway apparatus according to claim 1, wherein the Bluetooth Low Energy advertising packet comprises information from which a characteristic of the communication apparatus is derivable.

9. A gateway apparatus according to claim 1, wherein the circuitry is configured to transmit additional information with the received information to the web service.

10. A gateway apparatus according to claim 9, wherein the additional information comprises a location of the gateway apparatus.

11. A gateway apparatus according to claim 1, wherein the circuitry is configured to complete a security protocol to allow authentication and/or encryption of the information received from the communication apparatus via the established wireless connection.

12. A gateway apparatus according to claim 1, wherein:
the Bluetooth Low Energy advertising packet comprises an indicator of whether the communication apparatus is accepting a wireless connection with a gateway apparatus; and
in the absence of the communication apparatus requesting a wireless connection with a gateway apparatus, the circuitry is configured to establish a wireless connection with the communication apparatus only if the Bluetooth Low Energy advertising packet indicates the communication apparatus is accepting a wireless connection with a gateway apparatus.

13. A gateway apparatus according to claim 1, wherein the gateway apparatus is a smartphone.

14. A network service apparatus comprising circuitry configured to:
receive, via a gateway apparatus, an identifier of a communication apparatus and information from the communication apparatus, the identifier of the communication apparatus being transmitted to the gateway apparatus by the communication apparatus in a Bluetooth Low Energy advertising packet and the information from the communication apparatus being transmitted to the gateway apparatus by the communication apparatus via a wireless connection established with the gateway apparatus in response to an indicator in the Bluetooth Low Energy advertising packet indicating a wireless connection with a gateway apparatus is requested by the communication apparatus;
identify a web service associated with the identifier of the communication apparatus; and
transmit the received information to the identified web service.

15. A network service apparatus according to claim 14, wherein the circuitry is configured to access a database associating an identifier of the identified web service with the identifier of the communication apparatus.

16. A network service apparatus according to claim 14, wherein:
the information received from the communication apparatus is a request; and
the circuitry is configured to receive, from the identified web service, a response to the request; and
transmit the response to the request to the communication apparatus.

17-20. (canceled)

21. A communication apparatus comprising circuitry configured to:
wirelessly transmit, in a Bluetooth Low Energy advertising packet, an identifier of the communication apparatus and an indicator of whether the communication apparatus is requesting a wireless connection with a gateway apparatus;
establish, in response to receiving a wireless connection request from a gateway apparatus, a wireless connection with the gateway apparatus, the wireless connection request being received from the gateway apparatus when the Bluetooth Low Energy advertising packet indicates the communication apparatus is requesting a wireless connection with a gateway apparatus; and
transmit, via the established wireless connection, information associated with the identifier of the communication apparatus to the gateway apparatus.

22. A communication apparatus according to claim 21, wherein:
the Bluetooth Low Energy advertising packet is a first type of Bluetooth Low Energy advertising packet; and
the circuitry is configured to transmit a second type of Bluetooth Low Energy advertising packet for causing the gateway apparatus to enter a mode in which the first type of Bluetooth Low Energy advertising packet is receivable.

23. A communication apparatus according to claim 22, wherein the transmitted second type of Bluetooth Low Energy advertising packet is configured based on the transmitted first type of Bluetooth Low Energy advertising packet.

24. A communication apparatus according to claim 23, wherein the transmitted second type of Bluetooth Low Energy advertising packet is configured based on the identifier of the communication apparatus indicated by the transmitted first type of Bluetooth Low Energy advertising packet.

25-36. (canceled)
